(19) United States
(12) Patent Application Publication
(10) Pub. No.: US 2025/0286686 A1
(43) Pub. Date: Sep. 11, 2025

(54) SIDELINK SSB TRANSMISSION IN NR UNLICENSED

(71) Applicant: Apple Inc., Cupertino, CA (US)

(72) Inventors: Huaning Niu, San Jose, CA (US); Chunxuan Ye, San Diego, CA (US); Dawei Zhang, Saratoga, CA (US); Haitong Sun, Cupertino, CA (US); Hong He, San Jose, CA (US); Oghenekome Oteri, San Diego, CA (US); Sigen Ye, Whitehouse Station, NJ (US); Wei Zeng, Saratoga, CA (US); Yushu Zhang, Beijing (CN); Weidong Yang, San Diego, CA (US)

(21) Appl. No.: 18/859,768

(22) PCT Filed: Apr. 26, 2023
(86) PCT No.: PCT/US2023/020017

§ 371 Date: Oct. 24, 2024

Related U.S. Application Data
(60) Provisional application No. 63/335,707, filed on Apr. 27, 2022.

(51) Int. Cl. H04L 5/00; H04W 74/00

(52) U.S. Cl. CPC H04L 5/0053; H04W 74/002

(57) ABSTRACT

Disclosed are methods, systems, and computer-readable medium to perform operations including: identifying one or more sidelink synchronization signal block (S-SSB) transmission opportunities during an S-SSB window (S-SSBW); and transmitting on a sidelink channel one or more S-SSBs during the one or more S-SSB transmission opportunities.

### CROSS-REFERENCE TO RELATED APPLICATIONS

The present application claims priority to U.S. Prov. App. No. 63/335,707, filed on Apr. 27, 2022, entitled “SIDELINK SSB TRANSMISSION IN NR UNLICENSED,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have integrated vehicle communication, where vehicles or other mobile devices communicate or exchange vehicle related information. Such wireless communication networks are referred to as vehicle-to-everything (V2X) communication systems. V2X communication systems may be characterized as networks in which vehicles, UEs, and/or other devices and network entities exchange communications in order to coordinate traffic activity, among other possible purposes. V2X communications include communications conveyed between a vehicle (e.g., a wireless device or communication device constituting part of the vehicle, or contained in or otherwise carried along by the vehicle) and various other devices. V2X communications include vehicle-to-pedestrian (V2P), vehicle-to-infrastructure (V2I), vehicle-to-network (V2N), and vehicle-to-vehicle (V2V) communications, as well as communications between vehicles and other possible network entities or devices. V2X communications may also refer to communications between other non-vehicle devices participating in a V2X network for the purpose of sharing V2X-related information.

### SUMMARY

This disclosure describes methods and systems for communication of sidelink synchronization signal blocks (S-SSBs) on sidelink unlicensed. The disclosed methods and systems comply with the sidelink unlicensed regulatory guidelines described above. Among other things, this disclosure describes design aspects of S-SSBs. In particular, the disclosure describes the structure of S-SSB and sidelink synchronization sources and procedures.

In accordance with one aspect of the present disclosure, a method to be performed by a user equipment (UE) involves: identifying one or more sidelink synchronization signal block (S-SSB) transmission opportunities during an S-SSB window (S-SSBW); and transmitting on a sidelink channel one or more S-SSBs during the one or more S-SSB transmission opportunities.

Other versions include corresponding systems, apparatus, and computer programs to perform the actions of methods defined by instructions encoded on computer readable storage devices. These and other versions may optionally include one or more of the following features.

In some implementations, where identifying the one or more S-SSB transmission opportunities during the S-SSBW includes: determining that the S-SSBW has a fixed time length; and determining a number of the one or more S-SSB transmission opportunities based on a subcarrier spacing of the sidelink channel.

In some implementations, where identifying the one or more S-SSB transmission opportunities during the S-SSBW includes: determining a number of the one or more S-SSB transmission opportunities based on a predetermined number of candidate transmission opportunities.

In some implementations, where transmitting on the sidelink channel the one or more S-SSBs during the one or more S-SSB transmission opportunities includes: multiplexing, using frequency division multiplexing, the one or more S-SSBs with one or more Physical Sidelink Shared Channel (PSSCH) transmissions to generate one or more multiplexed transmissions; and transmitting the one or more multiplexed transmissions during the one or more S-SSB transmission opportunities.

In some implementations, where multiplexing the one or more S-SSBs with the one or more PSSCH transmissions to generate the one or more multiplexed transmissions includes: puncturing or rate-matching PSSCH resource blocks that overlap with S-SSB resource blocks.

In some implementations, where the one or more S-SSBs are frequency division multiplexed with one or more other S-SSBs from one or more other UEs.

In some implementations, where transmitting on the sidelink channel the one or more S-SSBs during the one or more S-SSB transmission opportunities includes: aligning a transmission boundary of the one or more S-SSBs with a transmission boundary of the one or more other S-SSBs.

In some implementations, where the one or more S-SSBs include one or more S-Primary Synchronization Signal/S-Secondary Synchronization Signal (S-PSS/S-SSS) blocks and one or more S-Physical Broadcast Channel (S-PBCH) transmissions, and where transmitting on the sidelink channel the one or more S-SSBs during the one or more S-SSB transmission opportunities includes: frequency domain multiplexing the one or more S-PSS/S-SSS blocks with the one or more S-PBCH transmissions to generate one or more multiplexed transmissions; and transmitting the one or more multiplexed transmissions during the one or more S-SSB transmission opportunities.

In some implementations, where a sensing gap separates the one or more S-SSB transmission opportunities.

In some implementations, where the one or more S-SSB transmission opportunities are located in a first S-SSB region of a plurality of S-SSB regions in a bandwidth of the sidelink channel, and where the plurality of S-SSB regions are frequency division multiplexed with one another.

In some implementations, where a number of the plurality of S-SSB regions is based on a subcarrier spacing (SCS) of the sidelink channel.

In some implementations, where the one or more S-SSBs include one or more S-Primary Synchronization Signal/S-Secondary Synchronization Signal (S-PSS/S-SSS) blocks and one or more S-Physical Broadcast Channel (S-PBCH) transmissions, and where transmitting on the sidelink channel the one or more S-SSBs during the one or more S-SSB transmission opportunities includes: using a hybrid frequency domain multiplexing and time domain multiplexing approach to multiplex the one or more S-PSS/S-SSS blocks with the one or more S-PBCH transmissions to generate one or more multiplexed transmissions; and transmitting the one or more multiplexed transmissions during the one or more S-SSB transmission opportunities.

In some implementations, where a first S-SSB of the one or more S-SSBs includes a S-Primary Synchronization Signal/S-Secondary Synchronization Signal (S-PSS/S-SSS) block and a S-Physical Broadcast Channel (S-PBCH) transmission, and where transmitting on the sidelink channel the one or more S-SSBs during the one or more S-SSB transmission opportunities includes: transmitting: (i) the S-PBCH transmission as an interlaced waveform over a first plurality of physical resource blocks in a first S-SSB transmission opportunity, and (ii) the S-PSS/S-SSS block over a second plurality of physical resource blocks in the first S-SSB transmission opportunity.

In some implementations, transmitting on the sidelink channel one or more S-SSBs during the one or more S-SSB transmission opportunities involves performing a channel access procedure to access the sidelink channel to perform the transmission.

In some implementations, the channel access procedure is one of a Type 2A channel access procedure or a Type 1 channel access procedure with priority class 1.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1A illustrates an example sidelink SSB structure, according to some implementations.

FIG. 1B illustrates an example communication system that includes sidelink communications, according to some implementations.

FIG. 2 illustrates an example sidelink SSB window, according to some implementations.

FIG. 3 illustrates a sidelink SSB window that includes S-SSBs from different UEs multiplexed using frequency division multiplexing, according to some implementations.

FIG. 4 illustrates a sidelink SSB window that includes S-PSS/S-SSS and S-PBCH that are multiplexed using frequency division multiplexing, according to some implementations.

FIG. 5 illustrates a sidelink SSB window that includes a plurality of S-SSB regions, according to some implementations.

FIG. 6A illustrates a sidelink SSB window that includes an interlaced waveform for S-PBCH, according to some implementations.

FIG. 6B illustrates a S-SSBW that includes a duplicated S-SSB structure, according to some implementations.

FIG. 6C illustrates a S-SSBW that includes an extended S-SSB structure, according to some implementations.

FIG. 7A illustrates a flowchart of an example method, in accordance with some implementations.

FIG. 7B illustrates a flowchart of another example method, in accordance with some implementations.

FIG. 8 illustrates a user equipment (UE), in accordance with some implementations.

FIG. 9 illustrates an access node, in accordance with some implementations.

### DETAILED DESCRIPTION

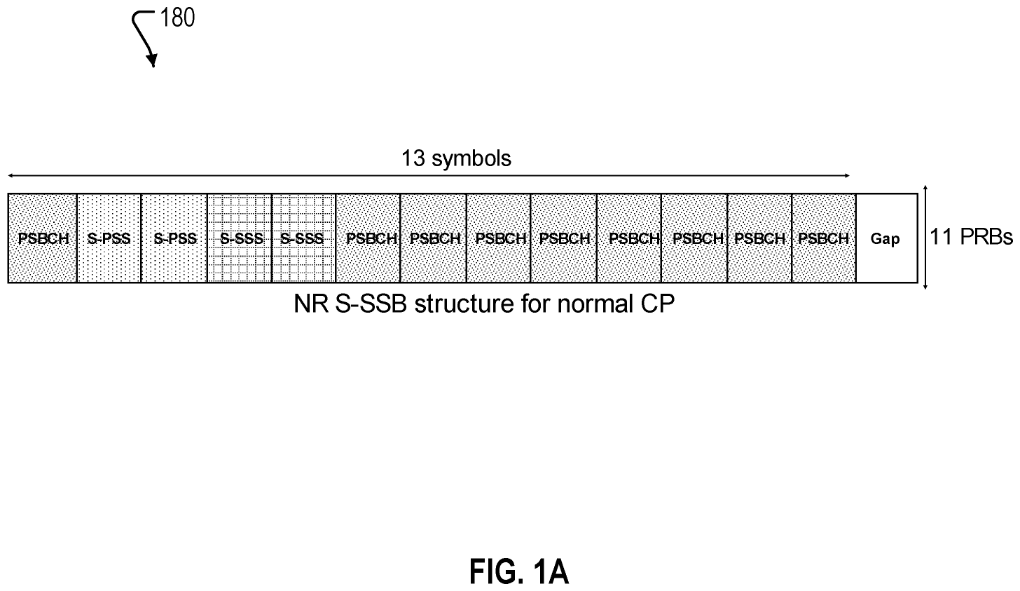

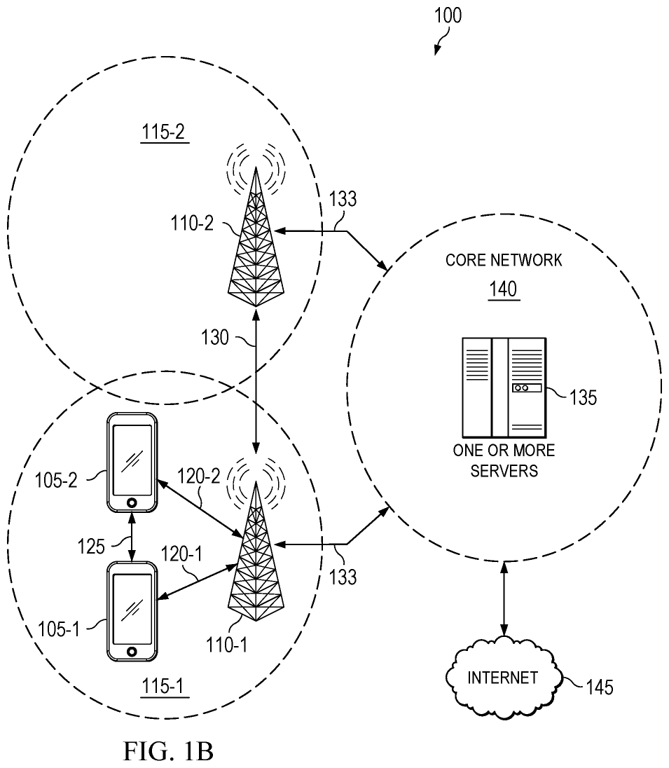

The Third Generation Partnership Project (3GPP) standards describe a Synchronization Signal Block (SSB) for a sidelink interface that operates in the licensed spectrum of New Radio (NR). The standards specify that the frequency location of the SSB is preconfigured and has no hypothesis detection, and that the structure for frequency resources is 11 Physical Resource Blocks (PRBs). The standards further specify that the time resources allocated for sidelink SSB with normal Cyclic Prefix (CP) are 13 symbols, and for sidelink SSB with extended CP are 11 symbols, with 6 Physical Sidelink Broadcast Channel (PSBCH) symbols after a Primary Synchronization Signal (PSS) and Secondary Synchronization Signal (SSS). An example of this structure is shown as structure 180 in FIG. 1A. The present disclosure describes features and designs for SSB for a sidelink interface operating in an unlicensed spectrum (also called sidelink unlicensed or SL-U).

Regulatory organizations have established guidelines for wireless communication and operation in unlicensed spectrum. These guidelines include regulatory guidelines that devices are expected to meet. One set of guidelines is related to transmission bandwidth and specifies that the transmission bandwidth should meet 80% of the Occupied Channel Bandwidth (OCB). This rule is referred to as the “80% OCB requirement.” More particularly, the guidelines specify that the OCB should be between 80% and 100% of the Nominal Channel Bandwidth (NCB). The Nominal Channel Bandwidth can be, for example, 20 Megahertz (MHz). The guidelines also specify an exception to the 80% OCB requirement. The exception, called the 2 MHz temporary exception, allows transmission under 2 MHz in scenarios where the 80% OCB requirement is not met.

This disclosure describes methods and systems for communication of sidelink synchronization signal blocks (S-SSBs) in an unlicensed spectrum. In some instances, the disclosed methods and systems may comply with the unlicensed regulatory guidelines described above. Among other things, this disclosure describes design aspects of S-SSBs. In particular, the disclosure describes the structure of S-SSB and sidelink synchronization sources and procedures.

FIG. 1B illustrates an example communication system 100 that includes sidelink communications, according to some implementations. It is noted that the system of FIG. 1B is merely one example of a possible system, and that features of this disclosure may be implemented in other wireless communication systems.

The following description is provided for an example V2X communication system 100 that operates in conjunction with fifth generation (5G) networks as provided by 3rd Generation Partnership Project (3GPP) technical specifications (TS). However, the example embodiments are not limited in this regard and the described embodiments may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards.

As shown, the V2X communication system 100 includes a number of user devices. As used herein in the context of V2X systems, and as defined above, the term “user devices” may refer generally to devices that are associated with mobile actors or traffic participants in the V2X system, i.e., mobile (able-to-move) communication devices such as vehicles and pedestrian user equipment (PUE) devices. More specifically, the V2X communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

As shown, certain user devices may be able to conduct communications with one another directly, i.e., without an intermediary infrastructure device such as base station 110-1. As shown, UE 105-1 may conduct V2X-related communications directly with UE 105-2. Similarly, the UE 105-2 may conduct V2X-related communications directly with UE 105-1. Such peer-to-peer communications may utilize a “sidelink” interface such as a PC5 interface. In certain embodiments, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations 110.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 105 may be physical hardware devices capable of running one or more applications, capable of accessing network services via one or more radio links 120 with a corresponding base station 110, and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs (not shown in FIG. 1B) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1st SCI for the purpose of sensing and broadcast communication, and the 2nd SCI carrying the remaining information for data scheduling of unicast/groupcast data transmission.

In some implementations, the sidelink 125 is established through an initial beam pairing procedure. In this procedure, the UEs 105 identify (e.g., using a beam selection procedure) one or more potential beam pairs that could be used for the sidelink 125. A beam pair includes a transmitter beam from a transmitter UE (e.g., UE 105-1) to a receiver UE (e.g., UE 105-2) and a receiver beam from the receiver UE to the transmitter UE. In some examples, the UEs 105 rank the one or more potential beam pairs. Then, the UEs 105 select one of the one or more potential beam pairs for the sidelink 125, perhaps based on the ranking.

The air interface between two or more UEs 105 or between a UE 105 and a UE-type RSU (not shown in FIG. 1B) may be referred to as a PC5 interface. To transmit/receive data to/from one or more eNBs 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1B, UE 105 may connect with base station 110-1 via link 120 and simultaneously connect with UE 105-2 via sidelink 125.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the V2X communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, a first UE, e.g., UE 105-1, is configured to transmit synchronization information to a second UE, e.g., UE 105-2, via a sidelink, e.g., sidelink 125, that is operating in an unlicensed spectrum. Like the synchronization information for sidelink in the licensed spectrum, the synchronization information can be carried in a sidelink synchronization signal block (S-SSB) that includes sidelink Physical Broadcast Channel (S-PBCH), sidelink Primary Synchronization Signal (S-PSS), and sidelink Secondary Synchronization Signal (S-SSS) symbols. In the following description, the transmitter UE that transmits the S-SSB is referred to interchangeably as the first UE and the transmitter UE, and the receiver UE that receives the S-SSB is referred to interchangeably as the second UE and the receiver UE.

In some implementations, the first UE is configured to transmit the S-SSB during a time domain window. The time domain window, called a sidelink SSB window (S-SSBW), can include one or more candidate S-PSS, S-SSS, and S-PBCH transmission opportunities in one or more slots. A S-SSB transmission opportunity is also referred to as a S-SSB sensing opportunity. In one example, the first UE is configured to transmit the S-SSB during a time domain window that is fixed in length. In this example, the number of candidate transmissions that can occur within the S-SSBW is a function of a subcarrier spacing (SCS) of the sidelink channel. For instance, the S-SSBW can have a fixed time length of 2 milliseconds (ms). For this window length, the maximum number of S-SSB transmission opportunities for 15 Kilohertz (KHz) SCS is 2, for 30 KHz SCS is 4, and for 60 KHz SCS is 8.

In another example, the S-SSBW includes a fixed number of SSB transmission opportunities irrespective of the SCS. In this example, the actual time length of the S-SSBW is a function of the SCS. For instance, the S-SSBW can include four candidate S-SSBs irrespective of the SCS. In this instance, the length of the S-SSBW is 4 ms for 15 KHz SCS, 2 ms for 30 KHz SCS, and 1 ms for 60 KHz SCS.

In some implementations, even if a S-SSBW includes a plurality of S-SSB transmission opportunities, only one successful S-SSB is actually transmitted during that S-SSBW. That is, if a UE successfully obtains channel access at one S-SSB transmission opportunity and successfully performs one S-SSB transmission within the S-SSBW, remaining S-SSB transmissions during the S-SSBW will be stopped. Note that, in some instances, the use of the S-SSBW may not meet the 80% OCB requirement described above. However, in such instances, the use of the S-SSBW can qualify for the exception to that requirement (i.e., the 2 MHz temporary exception).

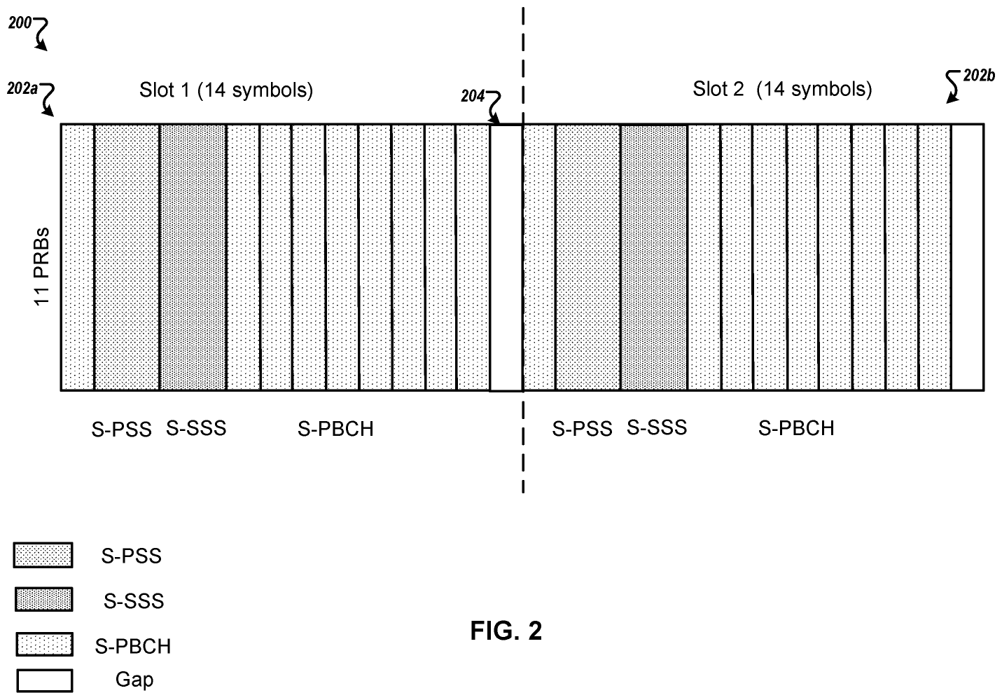

FIG. 2 illustrates an example sidelink SSB window (S-SSBW) 200, according to some implementations. In this example, the length of the S-SSBW 200 is 2 ms and the SCS of the sidelink channel is 15 KHz. Accordingly, the S-SSBW 200 includes two slots 202a, 202b and one S-SSB transmission opportunity in each slot. As shown in FIG. 2, each transmission opportunity includes one or more candidate S-PSS, S-SSS, and S-PBCH transmissions. As also shown in FIG. 2, each slot spans 14 symbols in time, and the candidate S-SSB occupies 11 PRBs in frequency. Furthermore, a last symbol of each slot may serve as a sensing gap 204 that separates the two slots.

In some implementations, the first UE and the second UE perform channel access procedures for accessing the unlicensed channel on which the S-SSB transmission is performed. In some examples, the first UE initiating the channel occupancy time (COT) structure is configured to select one of one or more options for channel access. In a first option, Transmission Option 1, the first UE performs the S-SSBW transmission using a Type 2A channel access procedure (e.g., 25 microsecond [us] one shot sensing), which is described in 3GPP TS 37.213 Section 4.1.2. In this option, each S-SSB transmission opportunity is less than 1 ms and is not multiplexed with PSSCH. In a second option, Transmission Option 2, the first UE uses a Type 1 channel access procedure with priority class 1 of supervised devices (e.g., as described in Table 4.2-1-1 of 3GPP TS 37.213). In a third option, Transmission Option 3, the first UE uses a Type 1 channel access procedure with priority class 1 of supervised devices (e.g., as described in Table 4.1.1-1 of 3GPP TS 37.213). The different types of channel access are described below.

In some examples, Type 1 is the full CCA procedure as below:
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration Ta or all the slots of the additional defer duration Ta are detected to be idle;
6) if the channel is sensed to be idle during all the slot durations of the additional defer duration T_{d}, go to step 4; else, go to step 5;
   The defer duration T_{d} consists of duration T_{f}=16 us immediately followed by mₚ consecutive slot durations Tₛₗ, and T_{f} includes an idle slot duration Tₛₗ at start of T_{f}. CW_{min p}≤CWₚ≤CW_{max,p} is the contention window.

CWmin and CWmax and corresponding priority has two options shown in Tables 1 and 2:

TABLE 1

| Channel | | | | | | |
|---|---|---|---|---|---|---|
| Access | | | | | | |
| Priority | | | | | | allowed |
| Class (p) | mₚ | CW_{min, p} | CW_{max, p} | T_{mcot, p} | | CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |

255, 511, 1023}

TABLE 2

| Channel | | | | | |
|---|---|---|---|---|---|
| Access | | | | | |
| Priority | | | | | allowed |
| Class (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided , otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

Type 2 channel access is one shot LBT. Type 2A Sidelink UE channel access procedure is defined as follows: If a sidelink UE is indicated to perform Type 2A sidelink channel access procedures, the sidelink UE uses Type 2A sidelink channel access procedures for a sidelink transmission. The sidelink UE may transmit the transmission immediately after sensing the channel to be idle for at least a sensing interval T_{short_ul}=25 us. T_{short_ul} consists of a duration T_{f}=16 us immediately followed by one slot sensing slot and T_{f} includes a sensing slot at start of T_{f}. The channel is considered to be idle for T_{short_ul} if both sensing slots of T_{short_ul} are sensed to be idle.

Type 2B Sidelink channel access procedure is defined as follows: If a sidelink UE is indicated to perform Type 2B sidelink channel access procedures, the sidelink UE uses Type 2B sidelink channel access procedure for a sidelink transmission. The UE may transmit the transmission immediately after sensing the channel to be idle within a duration of T_{f}=16 us. T_{f} includes a sensing slot that occurs within the last 9 us of T_{f}. The channel is considered to be idle within the duration T_{f} if the channel is sensed to be idle for total of at least 5 us with at least 4 us of sensing occurring in the sensing slot.

Type 2C sidelink channel access procedure is defined as follows: If a sidelink UE is indicated to perform Type 2C sidelink channel access procedures for a sidelink transmission, the sidelink UE does not sense the channel before the transmission. The duration of the corresponding sidelink transmission is at most 584 us.

Table 3 describes Priority Class dependent Channel Access parameters for Supervising Devices.

TABLE 3
Priority Class dependent Channel Access
parameters for Supervising Devices

| | | | | Maximum |
|---|---|---|---|---|
| Class # | p₀ | CWₘᵢₙ | CWₘₐₓ | Channel Occupancy Time (COT) |
| 4 | 1 | 3 | 7 | 2 ms |
| 3 | 1 | 7 | 15 | 4 ms |
| 2 | 3 | 15 | 63 | 6 ms |
| | | | | (see note 1 and note 2) |
| 1 | 7 | 15 | 1 023 | 6 ms |
| | | | | (see note 1) |

NOTE 1:
The maximum Channel Occupancy Time (COT) of 6 ms may be increased to 8 ms by inserting one or more pauses. The minimum duration of a pause shall be 100 μs. The maximum duration (Channel Occupancy) before including any such pause shall be 6 ms. Pause duration is not included in the channel occupancy time.
NOTE 2:
The maximum Channel Occupancy Time (COT) of 6 ms may be increased to 10 ms by extending CW to CW × 2 + 1 when selecting the random number q for any backoff(s) that precede the Channel Occupancy that may exceed 6 ms or which follow the Channel Occupancy that exceeded 6 ms. The choice between preceding or following a Channel Occupancy shall remain unchanged during the operation time of the device.
NOTE 3:
The values for p₀, CWₘᵢₙ, CWₘₐₓ are minimum values. Greater values are allowed.

In some implementations, the second UE sharing the COT is configured to select one of one or more options for channel access. In a first option, Receiving Option 1, if the S-SSB is within the shared COT from the other sidelink UE (i.e., the first UE), the second UE uses a Type 2A or 2B channel access procedure. In a second option, Receiving Option 2, if the S-SSB is less than 584 us with the shared COT, and the sensing gap is less than 16 us, then the second UE uses a Type 2C channel access procedure. This option does not involve a listen-before-talk (LBT) procedure.

Table 4 describes Priority Class dependent Channel Access parameters for Supervised Devices.

TABLE 4
Priority Class dependent Channel Access
parameters for Supervised Devices

| | | | | Maximum |
|---|---|---|---|---|
| Class # | p₀ | CWₘᵢₙ | CWₘₐₓ | Channel Occupancy Time (COT) |
| 4 | 2 | 3 | 7 | 2 ms |
| 3 | 2 | 7 | 15 | 4 ms |
| 2 | 3 | 15 | 1 023 | 6 ms |
| | | | | (see note 1) |
| 1 | 7 | 15 | 1 023 | 6 ms |
| | | | | (see note 1) |

NOTE 1:
The maximum Channel Occupancy Time (COT) of 6 ms may be increased to 8 ms by inserting one or more pauses. The minimum duration of a pause shall be 100 μs. The maximum duration (Channel Occupancy) before including any such pause shall be 6 ms. Pause duration is not included in the channel occupancy time.
NOTE 2:
The values for p₀, CWₘᵢₙ, CWₘₐₓ are minimum values. Greater values are allowed.

In some implementations, when transmitting a S-SSB, the first UE can multiplex the S-SSB with other sidelink data, e.g., PSSCH. Note that the first UE uses an interlaced waveform for PSSCH transmission, which allows the UE to meet the previously described regulatory requirements. In some implementations, the first UE is configured to select one of one or more options for multiplexing the S-SSB with other sidelink data. In a first option, Multiplexing Option 1, S-SSB and PSSCH are multiplexed using frequency division multiplexing (FDM). In this option, PSSCH uses an interlaced allocation, so part of the PSSCH resource blocks overlap with S-SSB. In one example, the overlapping resource blocks of S-SSB and PSSCH are punctured or rate matched. In another example, the PSSCH transmission takes one interlace, where the number of repetitions, N, is 10 or 11 PRBs. Further, the S-SSB is transmitted on localized RBs in corresponding OFDM symbols In this option, since PSSCH is multiplexed using FDM, the first UE uses Type 1 with priority 1 for channel access (e.g., Transmission Options 2 and 3 described above).

In a second option, Multiplexing Option 2, for the slots where S-SSB is transmitted, a plurality of transmitting sidelink UEs use FDM to multiplex their respective S-SSBs. For this option, the UEs use a Type 2A channel access procedure (e.g., Transmission Option 1 described above) to align the transmission boundaries, so that the transmission from one UE does not block the transmissions from the other UEs.

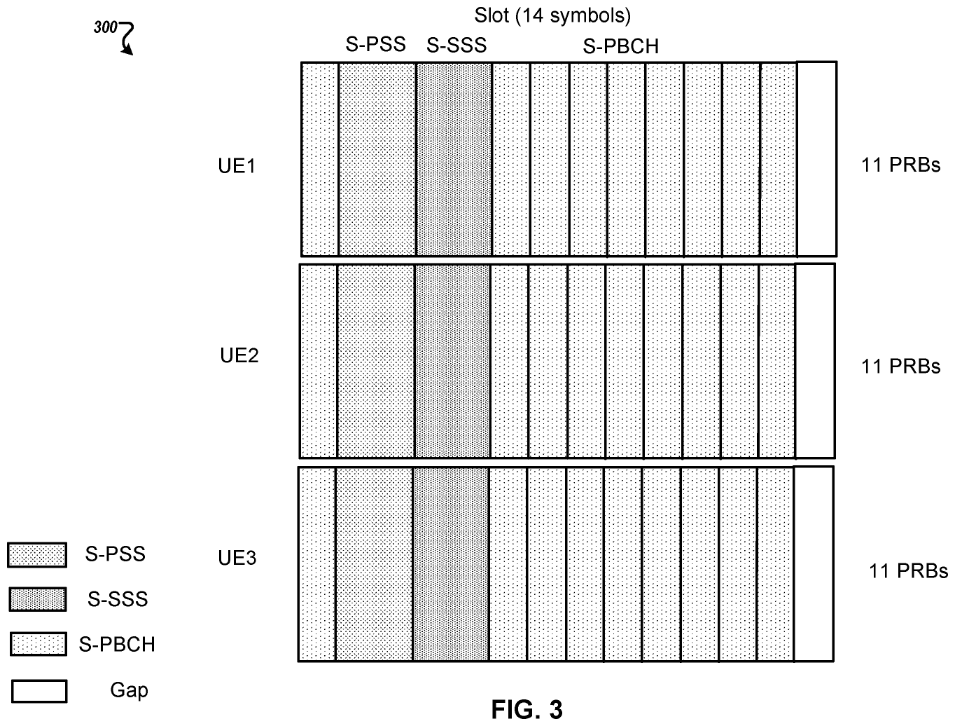

FIG. 3 illustrates a S-SSBW 300 that includes S-SSBs from different UEs multiplexed using frequency division multiplexing, according to some implementations. As shown in FIG. 3, a UE 1, a UE 2, and a UE 3 use frequency division multiplexing to multiplex their respective S-SSB transmissions on the same time slot. In this example, the S-SSBW has a length of a slot (e.g., 14 symbols) in the time domain, and each S-SSB transmission spans 11 PRBs in the frequency domain. As such, a receiving UE (not illustrated in FIG. 3) can receive the S-SSB transmissions from all three transmitting UEs in the same time slot. Although FIG. 3 illustrates three transmitting UEs, more than or less than three UEs can multiplex their S-SSBs over slots used for S-SSB transmission.

In some implementations, the first UE is configured to multiplex S-PSS/S-SSS and S-PBCH using frequency division multiplexing. In these implementations, due to the 10 decibel-milliwatts (dBm)/MHz spectrum density limitation (e.g., as set by regulatory bodies in ETSI EN 301 893), frequency division multiplexing S-PBCH does not impact the range of the S-PSS/S-SSS and S-PBCH (as opposed to time division multiplexing). Therefore, the S-SSB transmissions can be allocated to a wider frequency range than existing S-SSBs used in licensed spectrums. In some examples, S-PSS/S-SSS are spread across 11 PRBs, and S-PBCH is extended past the 11 PRBs for transmission reliability (e.g., more than 11 PRBs are used for transmission). In one example, 25 PRBs are used for S-PBCH. Furthermore, because the S-PSS/S-SSS and S-PBCH are frequency division multiplexed, the S-SSBW can include several S-SSB transmission opportunities in a single slot. The transmission opportunities within the S-SSBW can be separated by a sensing gap.

In some implementations, the first UE is configured to select one of one or more options for a sensing gap between each S-SSB block. In a first option, Gap Option 1, the first UE includes one symbol gap between each S-SSB block to allow other UEs to perform sensing before each S-SSB transmission. For example, this option can be used when different UEs frequency division multiplex S-SSB within one slot. In a second option, Gap Option 2, the first UE does not include a sensing gap between each S-SSB block. In a third option, Gap Option 3, the UE includes a 25 us sensing gap, and the remaining allocated symbol time between each S-SSB block includes a CP extension of the following S-SSB block. Here, the symbol length is based on based on numerology, and therefore, different SCS will have different remaining allocated time for the CP extension.

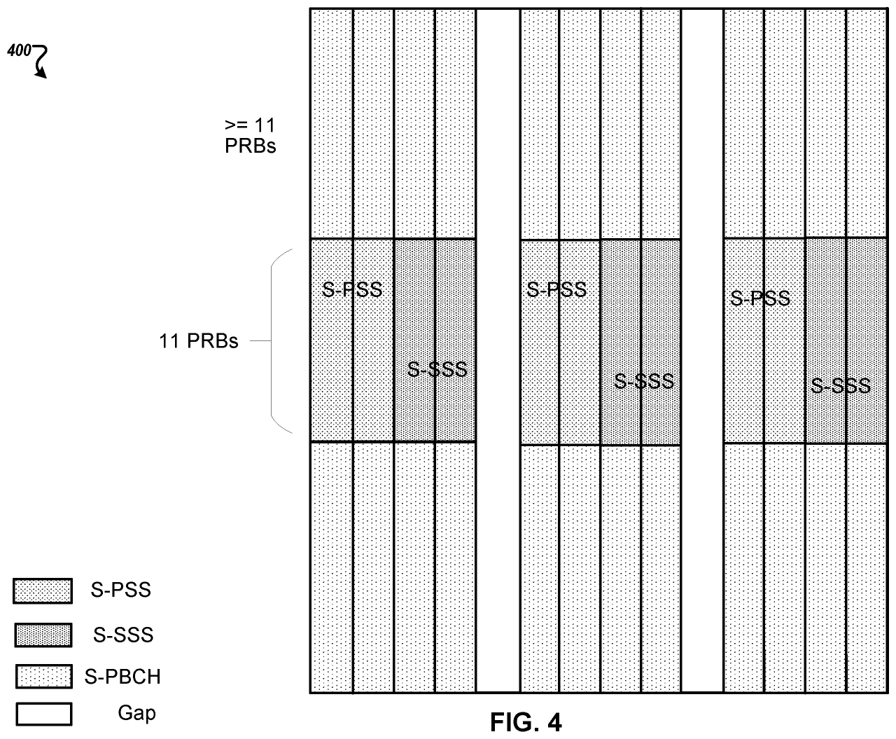

FIG. 4 illustrates a S-SSBW 400 that includes S-PSS/S-SSS and S-PBCH that are multiplexed using frequency division multiplexing, according to some implementations. As shown in FIG. 4, the S-SSBW 400 has a length of one slot (e.g., 14 symbols). The S-SSBW 400 includes three S-SSB transmission opportunities, where each transmission opportunity occupies four symbols and sensing gaps separate the transmission opportunities. As shown in FIG. 4, each transmission opportunity includes an S-PSS/S-SSS block that is frequency multiplexed with S-PBCH. In this example, the S-PSS/S-SSS block is spread across 11 PRBs, and the S-PBCH is spread across PRBs beyond the 11 PRBs.

In some implementations, the first UE is configured to multiplex S-PSS/S-SSS and S-PBCH using a hybrid time division multiplexing and frequency division multiplexing approach. In this approach, some symbols are allocated to S-PBCH and some symbols are allocated to S-PSS/S-SSS and S-PBCH in a frequency division multiplexing manner. For example, a first set of one or more symbols include a S-PSS/S-SSS block frequency division multiplexed with PBCH, and second set of one or more symbols, which include only PBCH, are time division multiplexed with the first set of symbols. The hybrid multiplexing approach may be designed such that the S-SSB transmission meets the 80% OCB requirement.

In some implementations, for different SCS, a different number of PRBs is allocated in the nominal band for S-SSB transmission. For some SCS, the nominal band can include more than one region for S-SSB transmission. For these SCS, different UEs can transmit S-SSB in the different regions within the nominal band. Like the previously described implementations, there is no multiplexing of localized SSB transmission with the interlaced S-PSSCH. In an example, a sidelink channel with 15 KHz SCS can include up to 3 S-SSB regions (which are frequency multiplexed). However, sidelink channel with 30 KHz SCS can include only one S-SSB region.

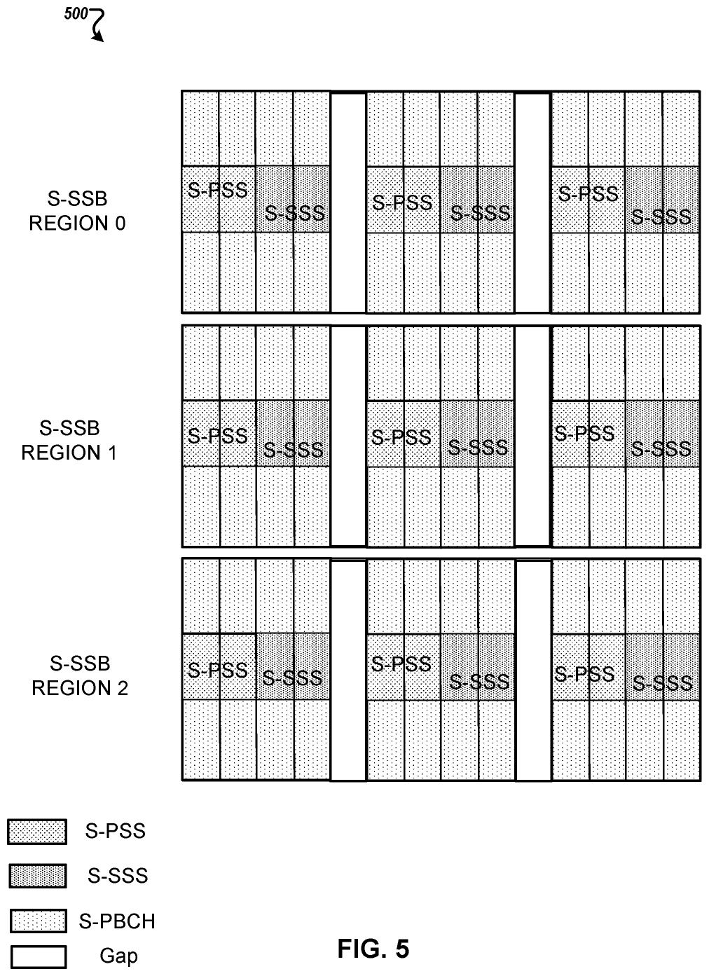

FIG. 5 illustrates a S-SSBW 500 that includes a plurality of S-SSB regions, according to some implementations. In this example, the sidelink channel has SCS of 15 KHz, and therefore, can include up to three S-SSB regions. As shown in FIG. 5, the S-SSBW 500 includes three S-SSB regions, namely S-SSB Region 0, S-SSB Region 1, and S-SSB Region 2, which are frequency multiplexed across the nominal band (e.g., 20 MHz). Each S-SSB region can carry a S-SSBW transmitted by a different UE. Further, each S-SSB region includes a S-PSS/S-SSS block that is frequency multiplexed with S-PBCH.

In some implementations, the first UE uses an interlaced waveform for S-PBCH within the channel band. In one example, the first UE uses an interlace wave for S-PSS, S-SSS and S-PBCH. In another example, the S-PBCH transmission takes one interlace, where the number of repetitions, N, is equal to 10 or 11 PRB. Further, S-PSS and S-SSS transmit on localized RBs in corresponding symbols. In some examples, different UEs can transmit S-PBCH in different interlaces. In some instances, an interlaced waveform can be used for the entire S-SSB, including the S-PSS, S-SSS, and S-PBCH. In this example, the localized PSS/SSS qualify for the 2 MHz temporary exemption. Further, the PBCH using interlaced waveform can have higher Tx power due to the 10 dBm/MHz spectrum density limitation.

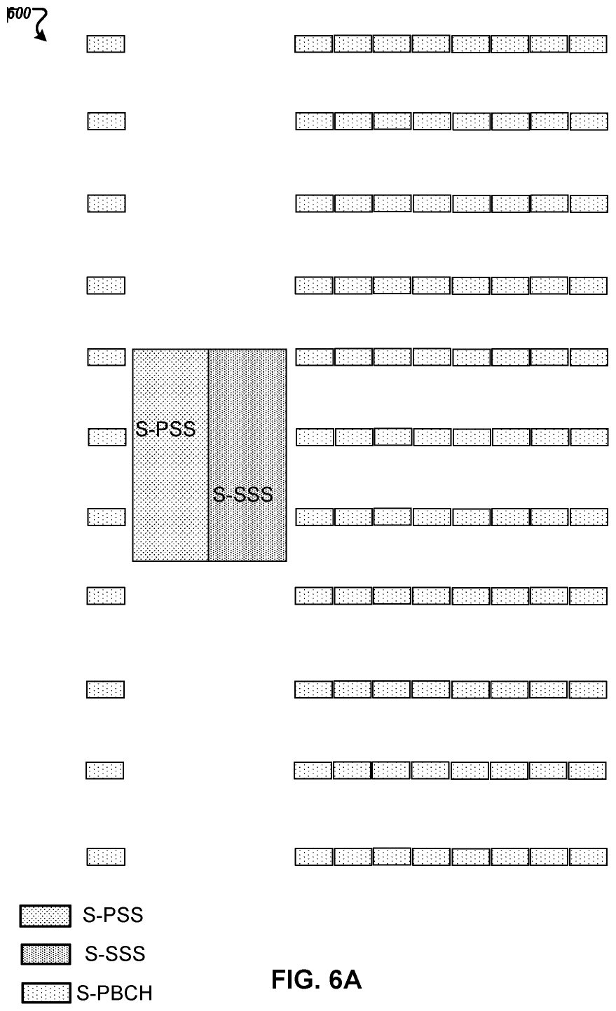

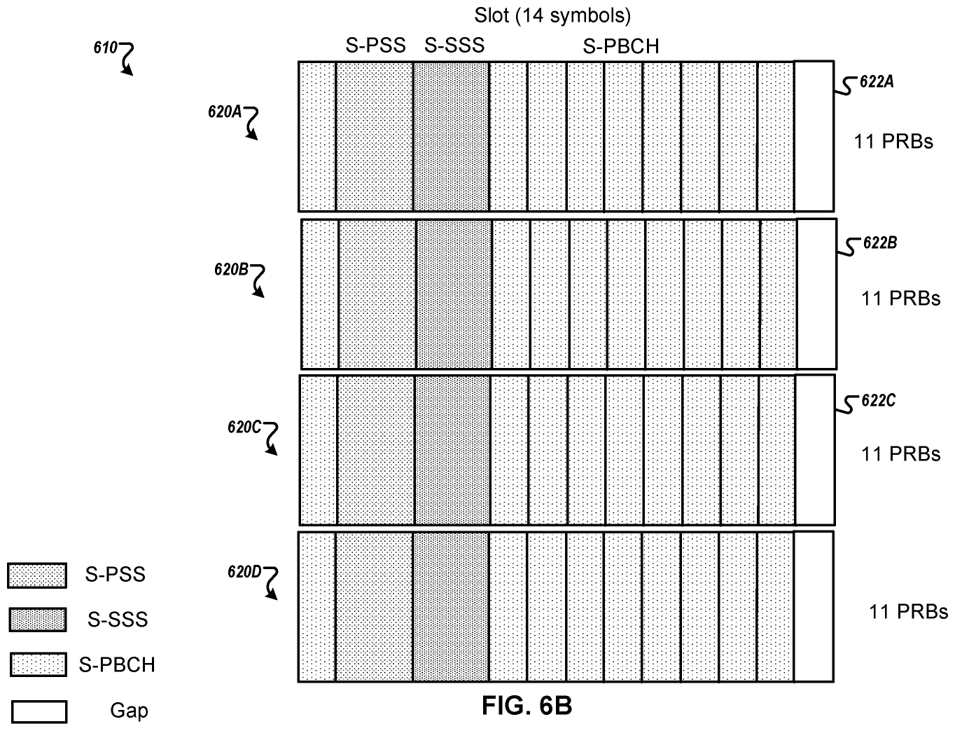

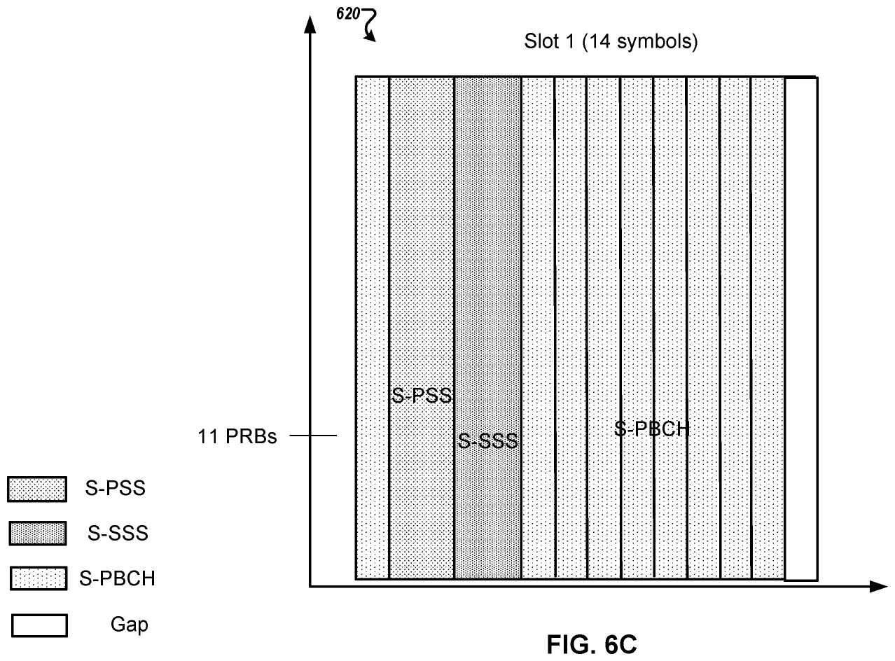

FIG. 6A illustrates a S-SSBW 600 that includes an interlaced waveform for S-PBCH, according to some implementations. As shown in FIG. 6, the S-SSBW 600 includes an S-PSS/S-SSS block. Further, the S-SSBW includes an interlaced S-PBCH across the channel band. In this example, the number repetitions of the interlace is 11 PRBs.

In some implementations, the UE is configured to duplicate the S-SSB structure in the frequency domain. In an example, the S-SSB structure that is duplicated in the frequency domain is structure 180 of FIG. 1A. In some examples, the number of PRBs across which the S-SSB structure is duplicated depends on the subcarrier spacing of the channel. For example, at a subcarrier spacing of 15 kHz, a 20 MHz sensing bandwidth (or nominal bandwidth) includes 51 PRBs. To meet the OCB requirement, an S-SSB structure that spreads over 11 PRBs could be duplicated 4 times (i.e., 44 PRBs) in the frequency domain. At a subcarrier spacing of 30 kHz, a 20 MHz sensing bandwidth includes 106 PRBs. Here, an S-SSB structure that spreads over 11 PRBs could be duplicated 8 times (i.e., 88 PRBs) in the frequency domain.

FIG. 6B illustrates a S-SSBW 610 that includes a duplicated S-SSB structure, according to some implementations. In this example, the subcarrier spacing of the channel is 15 kHz. Accordingly, a 20 MHz sensing bandwidth (or nominal bandwidth) includes 51 PRBs. To meet the OCB requirement, the S-SSBW 610 includes an S-SSB structure that spreads over 11 PRBs duplicated 4 times (i.e., 44 PRBs) in the frequency domain. Thus, as shown in FIG. 6B, S-PSS/S-SSS/S-PBCH is transmitted N times by repetition in frequency domain, and there is a gap between the repetitions to meet the OCB requirement. In FIG. 6B, repetitions 620A, 620B, 620C, 620D are multiplexed in frequency. Further, as shown in FIG. 6B, the repetitions are separated by gaps 622A, 622B, and 622C.

In some implementations, the UE is configured to extend an S-SSB structure in the frequency domain such that it occupies enough bandwidth to satisfy regulatory requirements. More specifically, for 30 KHz SCS, it is 44 RBs, for 15 KHz SCS, it is 88 RBs, and for 60 KHz SCS, it is 22 RBs. In one example, longer sequences for sidelink PSS and sidelink SSS are used to match a large number of subcarriers, where PSS is a maximum length sequence (m-sequence) of length 2\hat{ }m−1. So for 15 KHz SCS, it is 1023 subcarriers. For 30 KHz SCS, it is 511 subcarriers. Subsequently, the number of subcarriers for S-PBCH is increased to cover up to the available bandwidth, which enhances the S-PBCH transmission reliability.

FIG. 6C illustrates a S-SSBW 620 that includes an extended S-SSB structure, according to some implementations. In this example, the S-SSB structure is extended past the 11 PRBs of existing S-SSB structures.

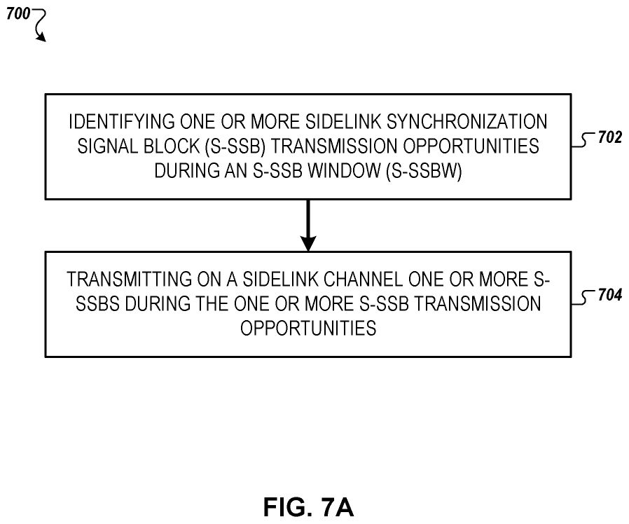

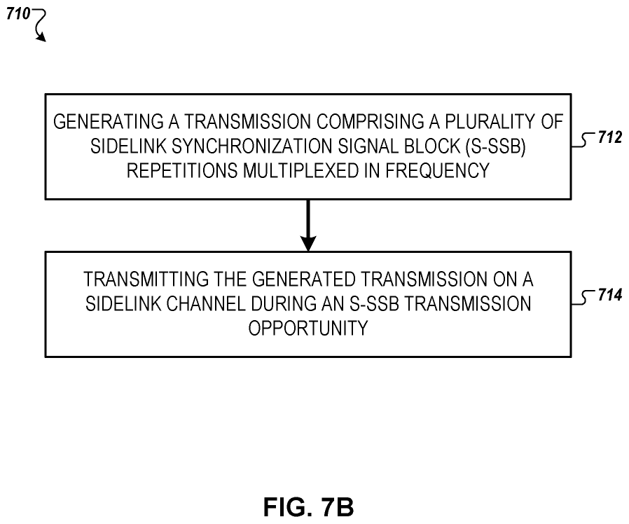

FIG. 7A illustrates a flowchart of an example method 700, in accordance with some embodiments. For clarity of presentation, the description that follows generally describes method 700 in the context of the other figures in this description. For example, method 700 can be performed by the UEs 105 of FIG. 1B. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order. In some implementations, the method 700 is performed by a UE.

At step 702, method 700 involves identifying one or more sidelink synchronization signal block (S-SSB) transmission opportunities during an S-SSB window (S-SSBW).

At step 704, method 700 involves transmitting on a sidelink channel one or more S-SSBs during the one or more S-SSB transmission opportunities.

In some implementations, where identifying the one or more S-SSB transmission opportunities during the S-SSBW includes: determining that the S-SSBW has a fixed time length; and determining a number of the one or more S-SSB transmission opportunities based on a subcarrier spacing of the sidelink channel.

In some implementations, where identifying the one or more S-SSB transmission opportunities during the S-SSBW includes: determining a number of the one or more S-SSB transmission opportunities based on a predetermined number of candidate transmission opportunities.

In some implementations, where transmitting on the sidelink channel the one or more S-SSBs during the one or more S-SSB transmission opportunities includes: multiplexing, using frequency division multiplexing, the one or more S-SSBs with one or more Physical Sidelink Shared Channel (PSSCH) transmissions to generate one or more multiplexed transmissions; and transmitting the one or more multiplexed transmissions during the one or more S-SSB transmission opportunities.

In some implementations, where multiplexing the one or more S-SSBs with the one or more PSSCH transmissions to generate the one or more multiplexed transmissions includes: puncturing or rate-matching PSSCH resource blocks that overlap with S-SSB resource blocks.

In some implementations, where the one or more S-SSBs are frequency division multiplexed with one or more other S-SSBs from one or more other UEs.

In some implementations, where transmitting on the sidelink channel the one or more S-SSBs during the one or more S-SSB transmission opportunities includes: aligning a transmission boundary of the one or more S-SSBs with a transmission boundary of the one or more other S-SSBs.

In some implementations, where the one or more S-SSBs include one or more S-Primary Synchronization Signal/S-Secondary Synchronization Signal (S-PSS/S-SSS) blocks and one or more S-Physical Broadcast Channel (S-PBCH) transmissions, and where transmitting on the sidelink channel the one or more S-SSBs during the one or more S-SSB transmission opportunities includes: frequency domain multiplexing the one or more S-PSS/S-SSS blocks with the one or more S-PBCH transmissions to generate one or more multiplexed transmissions; and transmitting the one or more multiplexed transmissions during the one or more S-SSB transmission opportunities.

In some implementations, where a sensing gap separates the one or more S-SSB transmission opportunities.

In some implementations, where the one or more S-SSB transmission opportunities are located in a first S-SSB region of a plurality of S-SSB regions in a bandwidth of the sidelink channel, and where the plurality of S-SSB regions are frequency division multiplexed with one another.

In some implementations, where a number of the plurality of S-SSB regions is based on a subcarrier spacing (SCS) of the sidelink channel.

In some implementations, where the one or more S-SSBs include one or more S-Primary Synchronization Signal/S-Secondary Synchronization Signal (S-PSS/S-SSS) blocks and one or more S-Physical Broadcast Channel (S-PBCH) transmissions, and where transmitting on the sidelink channel the one or more S-SSBs during the one or more S-SSB transmission opportunities includes: using a hybrid frequency domain multiplexing and time domain multiplexing approach to multiplex the one or more S-PSS/S-SSS blocks with the one or more S-PBCH transmissions to generate one or more multiplexed transmissions; and transmitting the one or more multiplexed transmissions during the one or more S-SSB transmission opportunities.

In some implementations, where a first S-SSB of the one or more S-SSBs includes a S-Primary Synchronization Signal/S-Secondary Synchronization Signal (S-PSS/S-SSS) block and a S-Physical Broadcast Channel (S-PBCH) transmission, and where transmitting on the sidelink channel the one or more S-SSBs during the one or more S-SSB transmission opportunities includes: transmitting: (i) the S-PBCH transmission as an interlaced waveform over a first plurality of physical resource blocks in a first S-SSB transmission opportunity, and (ii) the S-PSS/S-SSS block over a second plurality of physical resource blocks in the first S-SSB transmission opportunity.

In some implementations, transmitting on the sidelink channel one or more S-SSBs during the one or more S-SSB transmission opportunities involves performing a channel access procedure to access the sidelink channel to perform the transmission.

In some implementations, the channel access procedure is one of a Type 2A channel access procedure or a Type 1 channel access procedure with priority class 1.

FIG. 7B illustrates a flowchart of another example method 710, in accordance with some embodiments. For clarity of presentation, the description that follows generally describes method 710 in the context of the other figures in this description. For example, method 710 can be performed by the UEs 105 of FIG. 1B. It will be understood that method 710 can be performed, for example, by any suitable system, environment, software, hardware, or a combination of systems, environments, software, and hardware, as appropriate. In some implementations, various steps of method 710 can be run in parallel, in combination, in loops, or in any order. In some implementations, the method 710 is performed by a UE.

At step 712, method 710 involves generating a transmission comprising a plurality of sidelink synchronization signal block (S-SSB) repetitions multiplexed in frequency.

At step 714, method 710 involves transmitting the generated transmission on a sidelink channel during an S-SSB transmission opportunity.

In some implementations, each S-SSB repetition includes a S-Primary Synchronization Signal/S-Secondary Synchronization Signal (S-PSS/S-SSS) block and one or more S-Physical Broadcast Channel (S-PBCH) transmissions.

In some implementations, the transmission includes respective gaps between the plurality of S-SSB repetitions.

In some implementations, a number of the plurality of S-SSB repetitions is preconfigured.

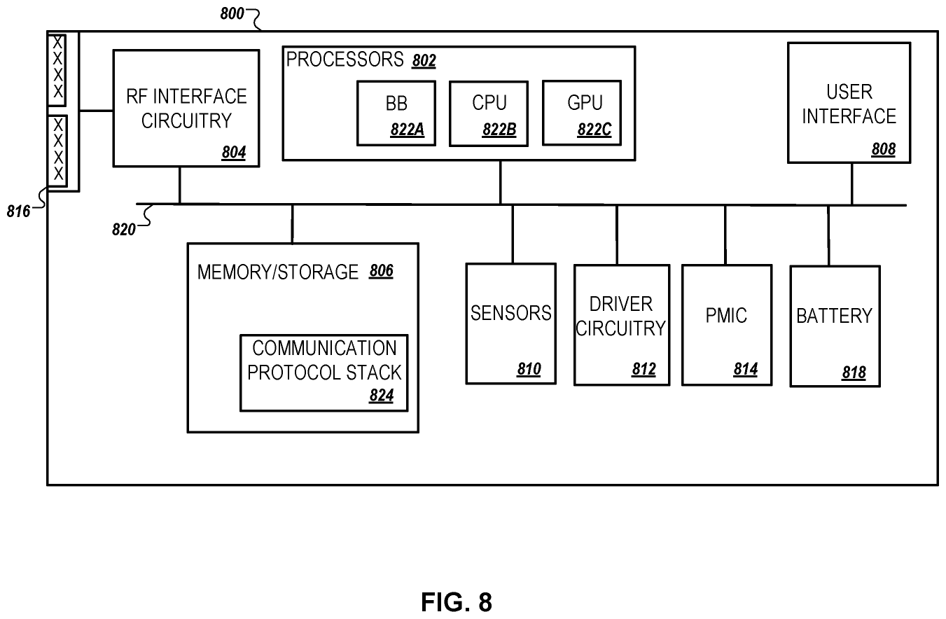

FIG. 8 illustrates a UE 800, in accordance with some implementations. The UE 800 may be similar to and substantially interchangeable with UEs 105 of FIG. 1B.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, one or more antennas 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some embodiments, the baseband processor circuitry 822A is configured to identify one or more sidelink synchronization signal block (S-SSB) transmission opportunities during an S-SSB window (S-SSBW). In some embodiments, the baseband processor circuitry 822A is configured to generate one or more S-SSBs for transmitting on a sidelink channel during the one or more S-SSB transmission opportunities. In some embodiments, the baseband processor circuitry 822A is configured to process one or more S-SSBs that are received from another UE.

In some embodiments, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 804. The baseband processor circuitry 822A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some embodiments, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antennas 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816.

In various embodiments, the RF interface circuitry 804 may be configured to transmit/receive signals in a manner compatible with NR access technologies.

The antenna 816 may include antenna elements to convert electrical signals into radio waves to travel through the air and to convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FRI or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some embodiments, the PMIC 814 may control, or otherwise be part of, various power saving mechanisms of the UE 800 including DRX as discussed herein. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

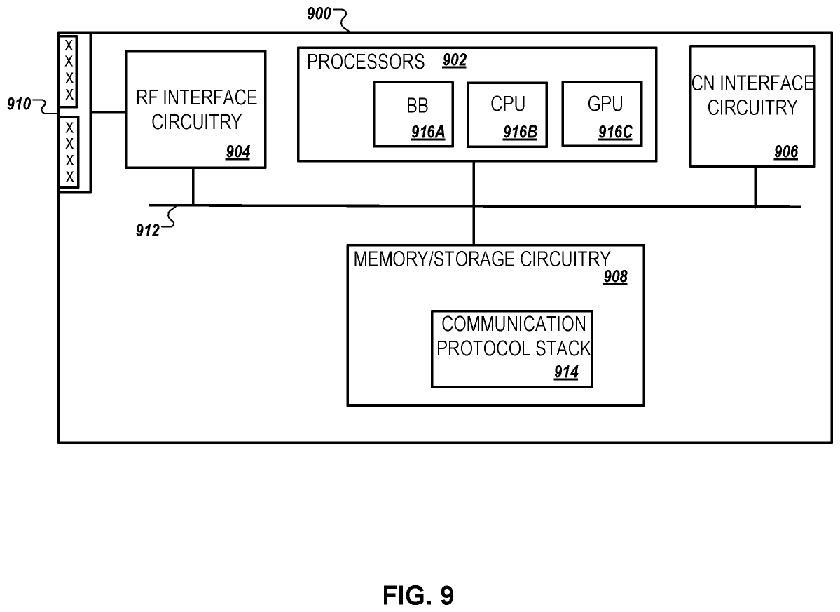

FIG. 9 illustrates an access node 900 (e.g., a base station or gNB), in accordance with some embodiments. The access node 900 may be similar to and substantially interchangeable with base stations 110. The access node 900 may include processors 902, RF interface circuitry 904, core network (CN) interface circuitry 906, memory/storage circuitry 908, and one or more antennas 910.

The components of the access node 900 may be coupled with various other components over one or more interconnects 912. The processors 902, RF interface circuitry 904, memory/storage circuitry 908 (including communication protocol stack 914), antennas 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various embodiments, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 900 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split where RRC and PDCP layers are operated by the CRAN/vBBUP and other L2 protocol entities are operated by the access node 900; a MAC/PHY split where RRC, PDCP, RLC, and MAC layers are operated by the CRAN/vBBUP and the PHY layer is operated by the access node 900; or a “lower PHY” split where RRC, PDCP, RLC, MAC layers and upper portions of the PHY layer are operated by the CRAN/vBBUP and lower portions of the PHY layer are operated by the access node 900.

In V2X scenarios, the access node 900 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following section, further exemplary embodiments are provided.

Example 1 includes a method that involves identifying one or more sidelink synchronization signal block (S-SSB) transmission opportunities during an S-SSB window (S-SSBW); and causing one or more S-SSBs to be transmitted on a sidelink channel during the one or more S-SSB transmission opportunities.

Example 2 includes a method of Example 1, where identifying the one or more S-SSB transmission opportunities during the S-SSBW involves determining that the S-SSBW has a fixed time length; and determining a number of the one or more S-SSB transmission opportunities based on a subcarrier spacing of the sidelink channel.

Example 3 includes a method of any of Examples 1-2, where identifying the one or more S-SSB transmission opportunities during the S-SSBW includes determining a number of the one or more S-SSB transmission opportunities based on a predetermined number of candidate transmission opportunities.

Example 4 includes a method of any of Examples 1-2, where causing the one or more S-SSBs to be transmitted on the sidelink channel during the one or more S-SSB transmission opportunities includes multiplexing, using frequency division multiplexing, the one or more S-SSBs with one or more Physical Sidelink Shared Channel (PSSCH) transmissions to generate one or more multiplexed transmissions; and causing the one or more multiplexed transmissions to be transmitted during the one or more S-SSB transmission opportunities.

Example 5 includes a method of Example 4, where multiplexing the one or more S-SSBs with the one or more PSSCH transmissions to generate the one or more multiplexed transmissions involves puncturing or rate-matching PSSCH resource blocks that overlap with S-SSB resource blocks.

Example 6 includes a method of any of Examples 1-5, where the one or more S-SSBs are frequency division multiplexed with one or more other S-SSBs from one or more other UEs.

Example 7 includes a method of Example 6, where causing the one or more S-SSBs to be transmitted on the sidelink channel during the one or more S-SSB transmission opportunities involves aligning a transmission boundary of the one or more S-SSBs with a transmission boundary of the one or more other S-SSBs.

Example 8 includes a method of any of Examples 1-2, where the one or more S-SSBs comprise one or more S-Primary Synchronization Signal/S-Secondary Synchronization Signal (S-PSS/S-SSS) blocks and one or more S-Physical Broadcast Channel (S-PBCH) transmissions, and wherein causing the one or more S-SSBs to be transmitted on the sidelink channel during the one or more S-SSB transmission opportunities involves frequency domain multiplexing the one or more S-PSS/S-SSS blocks with the one or more S-PBCH transmissions to generate one or more multiplexed transmissions; and causing the one or more multiplexed transmissions to be transmitted during the one or more S-SSB transmission opportunities.

Example 9 includes a method of Example 8, where a sensing gap separates the one or more S-SSB transmission opportunities.

Example 10 includes a method of Example 8, where the one or more S-SSB transmission opportunities are located in a first S-SSB region of a plurality of S-SSB regions in a bandwidth of the sidelink channel, and wherein the plurality of S-SSB regions are frequency division multiplexed with one another.

Example 11 includes a method of Example 10, where a number of the plurality of S-SSB regions is based on a subcarrier spacing (SCS) of the sidelink channel.

Example 12 includes a method of any of Examples 1-2, where the one or more S-SSBs comprise one or more S-Primary Synchronization Signal/S-Secondary Synchronization Signal (S-PSS/S-SSS) blocks and one or more S-Physical Broadcast Channel (S-PBCH) transmissions, and wherein causing the one or more S-SSBs to be transmitted on the sidelink channel during the one or more S-SSB transmission opportunities involves using a hybrid frequency domain multiplexing and time domain multiplexing approach to multiplex the one or more S-PSS/S-SSS blocks with the one or more S-PBCH transmissions to generate one or more multiplexed transmissions; and causing the one or more multiplexed transmissions to be transmitted during the one or more S-SSB transmission opportunities.

Example 13 includes a method of any of Examples 1-2, where a first S-SSB of the one or more S-SSBs comprises a S-Primary Synchronization Signal/S-Secondary Synchronization Signal (S-PSS/S-SSS) block and a S-Physical Broadcast Channel (S-PBCH) transmission, and wherein causing the one or more S-SSBs to be transmitted on the sidelink channel during the one or more S-SSB transmission opportunities involves causing: (i) the S-PBCH transmission to be transmitted as an interlaced waveform over a first plurality of physical resource blocks in a first S-SSB transmission opportunity, and (ii) the S-PSS/S-SSS block to be transmitted over a second plurality of physical resource blocks in the first S-SSB transmission opportunity.

Example 14 includes a method of any of Examples 1-2, where causing the one or more S-SSBs to be transmitted on the sidelink channel during the one or more S-SSB transmission opportunities involves performing a channel access procedure to access the sidelink channel to perform the transmission.

Example 15 includes a method of Example 14, where the channel access procedure is one of a Type 2A/2B/2C channel access procedure or a Type 1 channel access procedure with priority class 1.

Example 16 includes a method that involves generating a transmission comprising a plurality of sidelink synchronization signal block (S-SSB) repetitions multiplexed in frequency; and causing the transmission to be transmitted on a sidelink channel during an S-SSB transmission opportunity.

Example 17 includes a method of Example 16, where each S-SSB repetition comprises a S-Primary Synchronization Signal/S-Secondary Synchronization Signal (S-PSS/S-SSS) block and one or more S-Physical Broadcast Channel (S-PBCH) transmissions.

Example 18 includes a method of any of Examples 16-17, where the transmission involves respective gaps between the plurality of S-SSB repetitions.

Example 19 includes a method of Example 18, where the respective gaps satisfy a regulatory Occupied Channel Bandwidth (OCB) requirement.

Example 20 includes a method of any of Examples 16-18, where a number of the plurality of S-SSB repetitions is preconfigured.

Example 21 may include one or more non-transitory computer-readable media including instructions to cause an electronic device, upon execution of the instructions by one or more processors of the electronic device, to perform one or more elements of a method described in or related to any of examples 1-20, or any other method or process described herein.

Example 22 may include an apparatus including logic, modules, or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus including: one or more processors and one or more computer-readable media including instructions that, when executed by the one or more processors, cause the one or more processors to perform the method, techniques, or process as described in or related to any of examples 1-20, or portions thereof.

Example 25 may include a signal as described in or related to any of examples 1-20, or portions or parts thereof.

Example 26 may include a datagram, information element, packet, frame, segment, PDU, or message as described in or related to any of examples 1-20, or portions or parts thereof, or otherwise described in the present disclosure.

Example 27 may include a signal encoded with data as described in or related to any of examples 1-20, or portions or parts thereof, or otherwise described in the present disclosure.

Example 28 may include a signal encoded with a datagram, IE, packet, frame, segment, PDU, or message as described in or related to any of examples 1-20, or portions or parts thereof, or otherwise described in the present disclosure.

Example 29 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 30 may include a computer program including instructions, wherein execution of the program by a processing element is to cause the processing element to carry out the method, techniques, or process as described in or related to any of examples 1-20, or portions thereof. The operations or actions performed by the instructions executed by the processing element can include the methods of any one of examples 1-20.

Example 31 may include a signal in a wireless network as shown and described herein.

Example 32 may include a method of communicating in a wireless network as shown and described herein.

Example 33 may include a system for providing wireless communication as shown and described herein. The operations or actions performed by the system can include the methods of any one of examples 1-20.

Example 34 may include a device for providing wireless communication as shown and described herein. The operations or actions performed by the device can include the methods of any one of examples 1-20.

The previously-described examples 1-20 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-20.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to perform operations comprising:
identifying a plurality of sidelink synchronization signal block (S-SSB) transmission opportunities comprising an initial S-SSB transmission opportunity and one or more additional S-SSB transmission opportunities; and
causing a plurality of S-SSBs to be transmitted on a sidelink channel during the plurality of S-SSB transmission opportunities, the plurality of S-SSBs comprising an initial S-SSB and one or more additional S-SSBs.

2. The one or more processors of claim 1, wherein identifying the plurality of S-SSB transmission opportunities comprises:
determining a number of the plurality of S-SSB transmission opportunities based on a subcarrier spacing of the sidelink channel.

3. The one or more processors of claim 1, wherein identifying the plurality of S-SSB transmission opportunities comprises:
determining a number of the plurality of S-SSB transmission opportunities based on a predetermined number of candidate transmission opportunities.

4. The one or more processors of claim 1, wherein causing the plurality of S-SSBs to be transmitted on the sidelink channel during the plurality of S-SSB transmission opportunities comprises:
multiplexing, using frequency division multiplexing, the plurality of S-SSBs with one or more Physical Sidelink Shared Channel (PSSCH) transmissions to generate one or more multiplexed transmissions; and
causing the one or more multiplexed transmissions to be transmitted during the plurality of S-SSB transmission opportunities.

5. (canceled)

6. The one or more processors of claim 1, wherein the one or more additional S-SSBs are frequency division multiplexed with one or more other S-SSBs from one or more other UEs.

7. The one or more processors of claim 6, wherein causing the plurality of S-SSBs to be transmitted on the sidelink channel during the plurality of S-SSB transmission opportunities comprises:
aligning a transmission boundary of the plurality of S-SSBs with a transmission boundary of the one or more other S-SSBs.

8. The one or more processors of claim 1, wherein the plurality of S-SSBs comprise S-Primary Synchronization Signal/S-Secondary Synchronization Signal (S-PSS/S-SSS) blocks and S-Physical Broadcast Channel (S-PBCH) transmissions, and wherein causing the plurality of S-SSBs to be transmitted on the sidelink channel during the plurality of S-SSB transmission opportunities comprises:
frequency domain multiplexing the S-PSS/S-SSS blocks with the S-PBCH transmissions to generate one or more multiplexed transmissions; and
causing the one or more multiplexed transmissions to be transmitted during the plurality of S-SSB transmission opportunities.

9. The one or more processors of claim 1, wherein a sensing gap separates the plurality of S-SSB transmission opportunities.

10. (canceled)

11. (canceled)

12. (canceled)

13. The one or more processors of claim 1, wherein a first S-SSB of the plurality of S-SSBs comprises a S-Primary Synchronization Signal/S-Secondary Synchronization Signal (S-PSS/S-SSS) block and a S-Physical Broadcast Channel (S-PBCH) transmission, and wherein causing the plurality of S-SSBs to be transmitted on the sidelink channel during the plurality of S-SSB transmission opportunities comprises:
causing: (i) the S-PBCH transmission to be transmitted as an interlaced waveform over a first plurality of physical resource blocks in a first S-SSB transmission opportunity, and (ii) the S-PSS/S-SSS block to be transmitted over a second plurality of physical resource blocks in the first S-SSB transmission opportunity.

14. The one or more processors claim 1, wherein causing the plurality of S-SSBs to be transmitted on the sidelink channel during the plurality of S-SSB transmission opportunities comprises:
performing a channel access procedure to access the sidelink channel to perform the transmission.

15. The one or more processors of claim 14, wherein the channel access procedure is one of a Type 2A channel access procedure and a time duration of the plurality of transmission opportunities is at most 1 millisecond (1 ms).

16. One or more processors configured to perform operations comprising:
generating a transmission comprising a plurality of sidelink synchronization signal block (S-SSB) repetitions multiplexed in frequency; and
causing the transmission on a sidelink channel during an S-SSB transmission opportunity.

17. The one or more processors of claim 16, wherein each S-SSB repetition comprises a S-Primary Synchronization Signal/S-Secondary Synchronization Signal (S-PSS/S-SSS) block and S-Physical Broadcast Channel (S-PBCH) transmissions.

18. The one or more processors of claim 16, wherein the transmission comprises respective gaps between the plurality of S-SSB repetitions.

19. The one or more processors of claim 18, wherein the respective gaps satisfy a regulatory Occupied Channel Bandwidth (OCB) requirement.

20. The one or more processors of claim 16, wherein a number of the plurality of S-SSB repetitions is preconfigured.

21. (canceled)

22. A user equipment (UE) comprising:
a radio frequency transceiver;
one or more processers; and
memory storing instructions that, when executed by the one or more processers, cause the UE to perform operations comprising:
identifying a plurality of sidelink synchronization signal block (S-SSB) transmission opportunities comprising an initial S-SSB transmission opportunity and one or more additional S-SSB transmission opportunities; and
transmitting a plurality of S-SSBs on a sidelink channel during the plurality of S-SSB transmission opportunities, the plurality of S-SSBs comprising an initial S-SSB and one or more additional S-SSBs.

23. (canceled)

24. The UE of claim 22, wherein identifying the plurality of S-SSB transmission opportunities comprises:
determining a number of the plurality of S-SSB transmission opportunities based on a subcarrier spacing of the sidelink channel.

25. The UE of claim 22, wherein causing the plurality of S-SSBs to be transmitted on the sidelink channel during the plurality of S-SSB transmission opportunities comprises:
performing a channel access procedure to access the sidelink channel to perform the transmission.

26. The UE of claim 25, wherein the channel access procedure is one of a Type 2A channel access procedure and a time duration of the plurality of transmission opportunities is at most 1 millisecond (1 ms).
